(19) United States
(12) Patent Application Publication
(10) Pub. No.: US 2022/0167040 A1
(43) Pub. Date: May 26, 2022

(54) VOICE CONTROL OF A VIDEO PLAYBACK SYSTEM

(71) Applicant: Bose Corporation, Framingham, MA (US)

(72) Inventors: Derek Richardson, Somerville, MA (US); Sisi Sun, Ashland, MA (US); Ann Clark, Huntertown, IN (US); Melvin Chacko Kanasseril, Newton, MA (US)

(73) Assignee: Bose Corporation, Framingham, MA (US)

(21) Appl. No.: 17/533,704

(22) Filed: Nov. 23, 2021

Related U.S. Application Data
(60) Provisional application No. 63/117,450, filed on Nov. 23, 2020.

(51) Int. Cl. H04N 21/422; H04N 21/438; H04N 21/443; H04N 21/472

(52) U.S. Cl. CPC H04N 21/42203; H04N 21/4383; H04R 1/08; H04N 21/47217; H04N 21/42221; H04N 21/4436

(57) ABSTRACT

The present disclosure is directed to voice control of a video playback system. In an aspect, a device, such as an audio device (e.g., a soundbar) includes one or more speakers, one or more microphones, and one or more processors. The device also includes a connection to a display device (e.g., a television), where the speakers are configured to output audio related to video content displayed by the display device (such as playing audio for the video of a connected television). The device also includes one or more processors configured to, in response to the one or more microphones receiving a voice command, perform an action to cause a change in the video content displayed by the display device.

### CROSS REFERENCE TO RELATED APPLICATIONS

This application claims the benefit of U.S. Application Ser. No. 63/117,450, filed on Nov. 23, 2020, entitled VOICE CONTROL OF A VIDEO PLAYBACK SYSTEM, the content of which is incorporated herein in its entirety for all purposes.

### BACKGROUND

Interacting with video playback systems, such as televisions and devices that provide video content (e.g., cable boxes, digital video/DVD playing devices, video content streaming devices, etc.) typically requires a physical remote that receives commands from user input via button selection. Such interaction can provide an undesirable experience, as it requires having access to the physical remote, which can be troublesome when the remote is misplaced, lost, or simply out of reach. In addition, physical remotes require batteries, which die over time, requiring replacement and thereby increasing the time to video playback and control.

### SUMMARY

All examples and features mentioned below can be combined in any technically possible way.

In one aspect, a device includes: at least one electro-acoustic transducer; at least one microphone; a connection to a display device, wherein the at least one electro-acoustic transducer is configured to output audio related to video content displayed by the display device; and at least one processor configured to, in response to the microphone receiving a voice command, perform an action to cause a change in the video content displayed by the display device.

Examples may include one of the following features, or any combination thereof.

In some examples, the device is a soundbar. In some examples, the at least one electro-acoustic transducer includes multiple electro-acoustic transducers. In some examples, the at least one microphone includes multiple microphones arranged in an array for far-field voice pick up. In some examples, the connection is a wired connection via one of an optical audio cable, a High-Definition Multimedia Interface (HDMI) cable, or a Universal Serial Bus (USB) cable. In some such examples, the action to cause a change in the video content displayed by the display device is performed by sending data via the wired connection. In some examples, the connection is a wireless connection.

In some examples, the display device is one of a television, a computer monitor, or a mobile device display. In some examples, the action causes a change to a channel providing the video content displayed by the display device. In some such examples, the voice command includes the channel number. In further such examples, the voice command includes the channel name, and the at least one processor is further configured to cause the channel name to be searched to determine a corresponding channel number. In some such examples, the channel name is searched using an internet-based service to obtain the corresponding channel number.

In some examples, the voice command includes a video content service and the action causes the video content displayed by the display device to change to the video content service. In some such examples, the at least one processor is further configured to, in response to the voice command including the video content service, send an input change command to the display device to an input associated with the video content service. In some such examples, the at least one processor is further configured to provide a setup process that enables a user to associate the input with the video content service.

In some examples, the action to cause a change in the video content displayed by the display device includes changing an input or source of the video content. In some such examples, the at least one processor is further configured to allow a user to rename an input or source of video content, and wherein changing an input or source of the video content is performed in response to the voice command including a renamed input or source of video content.

In some examples, the at least one processor is further configured to, in response to the microphone receiving the voice command, determine a power state of the display device, and, in response to the display device power state being off, send a power command to the display device. In some such examples, determining the power state of the display device includes determining whether audio data is being received via the connection with the display device.

In some examples, the change in the video content displayed by the display device includes at least one of playing, pausing, stopping, rewinding, fast forwarding, skipping forward, skipping backward, or change episode. In some examples, the device further includes at least one infrared (IR) blaster, wherein the action causes the IR blaster to transmit a command to a video content device connected to the display device to cause the change in the video content displayed by the display device. In some such examples, the video content device connected to the display device includes at least one of a set-top box, a cable box, a satellite box, a television tuner, a video streaming device, a gaming console, a mobile computing device, or a digital video disc (DVD) playback device. In further such examples, the device further includes a housing, wherein the at least one electro-acoustic transducer, the at least one microphone, the at least one processor, and the at least one IR blaster are all included in or on the housing.

In some examples, the device does not include a display. In some examples, the device provides the video content to the display device. In some such examples, the device receives the video content via an internet connection. In further such examples, the at least one electro-acoustic transducer is configured to output the audio related to the video content displayed on the display device based on audio data associated with the video content it provides to the display device. In some examples, the at least one electro-acoustic transducer is configured to output the audio related to the video content displayed on the display device based on audio data received via the connection.

In some examples, the voice command includes a first portion and a second portion, the first portion including a wake word and the second portion including instructions relating to the action to cause a change in the video content displayed by the display device. In some such examples, the device simultaneously recognizes multiple different wake words that access different services and/or actions.

In another aspect, a method of voice controlling a video playback system using a device, the device including at least one electro-acoustic transducer, at least one microphone, a connection to a display device, and at least one processor, the method includes: outputting, via the at least one electro-acoustic transducer, audio related to video content displayed by the display device; and in response to the microphone receiving a voice command, performing an action to cause a change in the video content displayed by the display device.

Examples may include one of the following or aforementioned features, or any combination thereof.

In some examples, the device is a soundbar. In some examples, the at least one electro-acoustic transducer includes multiple electro-acoustic transducers. In some examples, the at least one microphone includes multiple microphones arranged in an array for far-field voice pick up. In some examples, the connection is a wired connection via one of an optical audio cable, a High-Definition Multimedia Interface (HDMI) cable, or a Universal Serial Bus (USB) cable. In some such examples, the action to cause a change in the video content displayed by the display device is performed by sending data via the wired connection. In some examples, the connection is a wireless connection.

In some examples, the display device is one of a television, a computer monitor, or a mobile device display. In some examples, the action causes a change to a channel providing the video content displayed by the display device. In some such examples, the voice command includes the channel number. In further such examples, the voice command includes the channel name, and the at least one processor is further configured to cause the channel name to be searched to determine a corresponding channel number. In some such examples, the channel name is searched using an internet-based service to obtain the corresponding channel number.

In some examples, the voice command includes a video content service and the action causes the video content displayed by the display device to change to the video content service. In some such examples, the method further includes, in response to the voice command including the video content service, send an input change command to the display device to an input associated with the video content service. In some such examples, the method further includes providing a setup process that enables a user to associate the input with the video content service.

In some examples, the action to cause a change in the video content displayed by the display device includes changing an input or source of the video content. In some such examples, the method further includes allowing a user to rename an input or source of video content, and wherein changing an input or source of the video content is performed in response to the voice command including a renamed input or source of video content.

In some examples, the method further includes, in response to the microphone receiving the voice command, determine a power state of the display device, and, in response to the display device power state being off, send a power command to the display device. In some such examples, determining the power state of the display device includes determining whether audio data is being received via the connection with the display device.

In some examples, the change in the video content displayed by the display device includes at least one of playing, pausing, stopping, rewinding, fast forwarding, skipping forward, skipping backward, or change episode. In some examples, the device further includes at least one infrared (IR) blaster, wherein the action causes the IR blaster to transmit a command to a video content device connected to the display device to cause the change in the video content displayed by the display device. In some such examples, the video content device connected to the display device includes at least one of a set-top box, a cable box, a satellite box, a television tuner, a video streaming device, a gaming console, a mobile computing device, or a digital video disc (DVD) playback device. In further such examples, the device further includes a housing, wherein the at least one electro-acoustic transducer, the at least one microphone, the at least one processor, and the at least one IR blaster are all included in or on the housing.

In some examples, the device does not include a display. In some examples, the device provides the video content to the display device. In some such examples, the device receives the video content via an internet connection. In further such examples, the at least one electro-acoustic transducer is configured to output the audio related to the video content displayed on the display device based on audio data associated with the video content it provides to the display device. In some examples, the at least one electro-acoustic transducer is configured to output the audio related to the video content displayed on the display device based on audio data received via the connection.

In some examples, the voice command includes a first portion and a second portion, the first portion including a wake word and the second portion including instructions relating to the action to cause a change in the video content displayed by the display device. In some such examples, the device simultaneously recognizes multiple different wake words that access different services and/or actions.

In some examples, implementations include one of the above and/or below features, or any combination thereof.

### BRIEF DESCRIPTION OF THE DRAWINGS

FIG. 1 illustrates an example voice command (“Alexa, change channel to ESPN”) issued to a soundbar to provide voice control of a video playback system, in accordance with some implementations.

FIG. 2 is an example flow chart illustrating a method of providing a voice command to a soundbar to provide voice control of a video playback system, in accordance with some implementations.

FIG. 3 illustrates an example system for providing voice control of a video playback system, in accordance with some implementations.

FIG. 4 illustrates an example system block diagram of a component overview for a system to provide voice control of a video playback system, in accordance with some implementations.

FIGS. 5A-B illustrate a firmware update using the example system block diagram of FIG. 4, in accordance with some implementations.

FIGS. 6A-B illustrate setting up a cable box source using the example system block diagram of FIG. 4, in accordance with some implementations.

FIG. 7 illustrates setting the postal code and cable provider using the example system block diagram of FIG. 4, in accordance with some implementations.

FIG. 8 illustrates providing an example voice command (“Alexa, change channel to 123”) using the example system block diagram of FIG. 4, in accordance with some implementations.

FIG. 9 illustrates providing another example voice command (“Alexa, change channel to ESPN”) using the example system block diagram of FIG. 4, in accordance with some implementations.

FIG. 10 illustrates an example voice command (“Alexa, switch to Bluetooth”) issued to a soundbar to provide voice control of a video playback system, in accordance with some implementations.

FIGS. 11A-B illustrate a flow chart for switching the input to Bluetooth using the example system block diagram of FIG. 4, in accordance with some implementations.

FIG. 12 illustrates a flow chart for pushing commands to a streaming device (e.g., a ROKU box) using the example system block diagram of FIG. 4, in accordance with some implementations.

FIGS. 13A-B illustrate a flow chart for selecting an input for a streaming device (e.g., a ROKU box) using the example system block diagram of FIG. 4, in accordance with some implementations.

FIGS. 14A-C illustrate a flow chart for setting up a television (e.g., a Sony Bravia TV) using the example system block diagram of FIG. 4, in accordance with some implementations.

FIGS. 15A-C illustrate a flow chart for setting up a source device using the example system block diagram of FIG. 4, in accordance with some implementations.

FIG. 16 illustrates a system block diagram of a device controller (DeviceController) for a system to provide voice control of a video playback system, in accordance with some implementations.

### DETAILED DESCRIPTION

As previously described, controlling video playback systems, particularly systems with multiple different devices/platforms, includes a number of issues. In addition to the aforementioned issues that arise when a remote control is misplaced or lost, out of reach, or lacks working batteries, physical remotes typically have buttons that are dedicated to a specific function, resulting in a limited set of available command options. Further, physical remotes are typically unintuitive with respect to requesting desired content, as physical remotes include options to change channels and inputs, and to access menus, as opposed to providing content-related options. All of these issues are exacerbated when multiple different devices are included in a video playback system, such as including a cable box, gaming console, streaming device, and/or digital video/DVD player with a television (or other display device).

Thus, the present disclosure describes devices and methods for voice control of a video playback system. The video playback system includes a display device, which in some implementations is a television (TV), but other display devices could also be used, such as a computer monitor or a mobile device display. For ease of description, the device for allowing voice control of a video playback system is primarily described herein in the context of a soundbar that is configured to connect to the display device of the video playback system, but the present disclosure is not intended to be so limited unless explicitly stated otherwise. In some implementations, the soundbar is connected to the display device, such as a TV, using a wired connection (e.g., via an optical audio, a High-Definition Multimedia Interface (HDMI) cable, or a Universal Serial Bus (USB) cable) and/or a wireless connection (e.g., via a Bluetooth connection, Wi-Fi connection, or any other suitable wireless protocol). The soundbar is configured to output audio related to video content displayed on the display device using one or more electro-acoustic transducers included in and/or on the soundbar (e.g., in a housing of the soundbar).

The soundbar also includes one or more microphones for picking up voice commands to perform various actions, such as actions affecting volume of the soundbar, muting of the soundbar, audio playback commands (e.g., play, pause, stop, track forward, track backward, skip forward, skip backward, shuffle, repeat, etc.), and/or content played by the soundbar (e.g., the song, artist, or radio played by the soundbar). The voice commands can also be used to perform an action that causes a change in the video content displayed by the display device. Such actions are described in detail herein, but they can generally include changing the channel of the content (e.g., by number or name), changing the input or source of the content, controlling playback or transport of the content (e.g., play, pause, stop, fast forward, rewind, skip forward, skip backward, etc.), changing the episode being played (e.g., skipping to the next episode), launching an application (e.g., a video streaming application, such as Netflix, Prime Video, or Disney+), and other features as variously described herein. In some implementations, actions that cause a change in the video content displayed by the display device could be expressed as changing from first content to second content different from the first content, such as switching to a different channel, a different show, a different episode of the same show, or a different source of content, to provide some examples. Other actions can also be included in some implementations that don't change the video content displayed by the display device, such as powering the TV on or off, displaying information related to the video content, displaying a menu or guide, recording the content, or launching an app that overlays the video content (e.g., a sports or weather app), to provide some examples.

The soundbar (or more generally, the audio device) may include any other componentry as is known in the art, such as one or more controllers, processors, power managers, connection ports (such as for powering the soundbar or providing data connections), lights (e.g., status LEDs), or control features (e.g., physical or capacitive touch buttons), to provide some example components. Numerous different variations and configurations will be apparent in light of this disclosure.

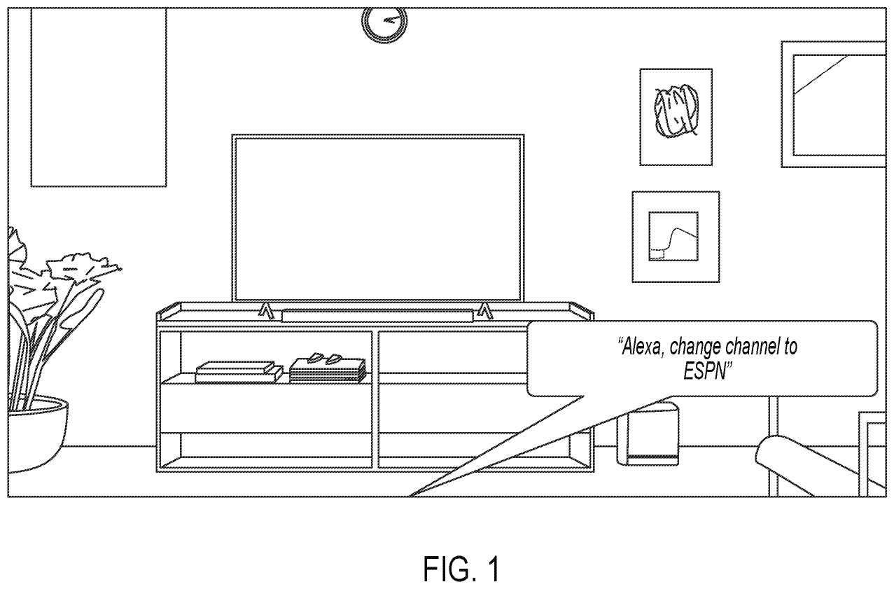

In an example implementation, a user can say a single voice command to the soundbar while the TV and/or soundbar are powered off (or are at least in a low power state, which includes the at least one microphone of the soundbar still listening for such voice commands) to cause the television and/or soundbar to power, cause the appropriate content to be selected, and to begin playback of the video on the television and related audio through the soundbar. For instance, as shown in FIG. 1, a user could merely state “Alexa, watch ESPN”, which could cause the TV to power on or come out of a standby/low power state (e.g., via a connected cable, such as an HDMI cable, or an IR blaster command, where the IR blaster is included in and/or on the soundbar), cause the soundbar to power on or come out of a standby/low power state, cause the soundbar to send a command to the TV to switch the TV to the proper input or source (e.g., switch to HDMI1, which could again be via a connected cable or an IR blaster command), set the soundbar to a predetermined or preconfigured volume level (e.g., a default volume level, a volume level associated with the command, or a volume level associated with the voice of the user), send one or more IR commands (e.g., via an IR blaster included in and/or on the soundbar) to a cable box connected to the TV to power on the cable device or cause it to come out of a standby/low power state, determine a channel number to send to the cable box to tune it to ESPN, and/or send the channel number (e.g., via the IR blaster) to the cable box to change it to ESPN, in no particular order or in an order optimized for the given actions to be implemented as can be understood based on this disclosure. Note that in some such implementations, the aforementioned actions may be optional and/or unnecessary. For instance, an action may be unnecessary based on the soundbar knowing the states of various devices (e.g., the soundbar may already know that the TV is on based on it already receiving audio data from a connection to the TV). Understandably, it would take numerous different user inputs and possibly numerous different physical remotes to perform the same actions previously described for the single “Alexa, watch ESPN” voice command. Moreover, a user would not have to locate the physical remote(s) prior to issuing those commands.

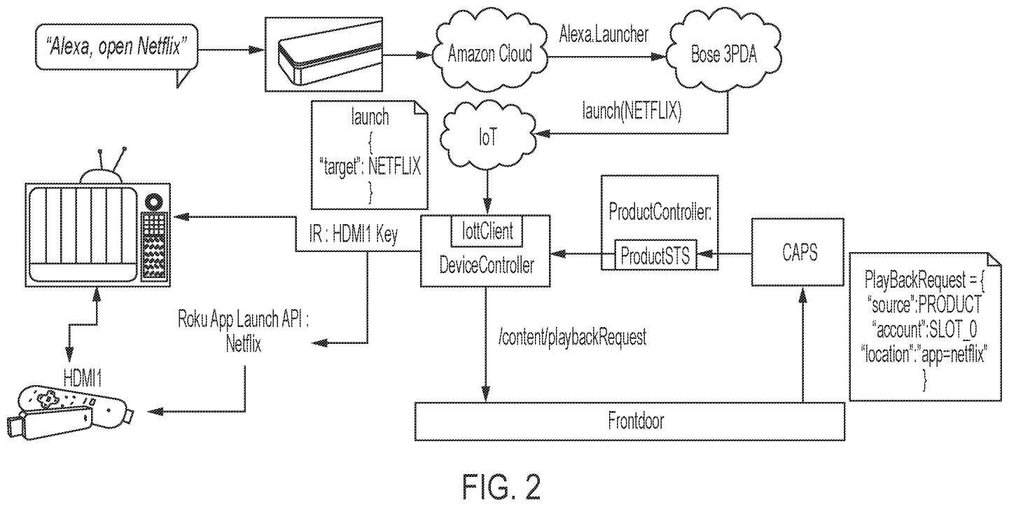

FIG. 2 is an example flow chart illustrating a method of providing a voice command to a soundbar to provide voice control of a video playback system, in accordance with some implementations. The method starts with a user issuing a voice command, specifically “Alexa, open Netflix”. In this example, “Alexa” is a wake word, and more specifically, it is the wake word used to access the Alexa virtual assistant developed by Amazon.com, Inc. (referred to herein as simply “Amazon”). Further, Amazon's video skill kit (VSK) is referred to herein and in the Figures as a service that helps enable portions of the techniques variously described herein. However, the present disclosure is not intended to be limited to Amazon's Alexa for such portions or for the wake word functionality of the voice command, but such services are used in some implementations.

Continuing with FIG. 2, the voice command (“Alexa, open Netflix”) is received by one or more microphones on the soundbar and sent to the Amazon cloud for processing. The Alexa. Launcher helps to determine the actual words that were stated, which is provided to the Bose 3PDA (third party developer application) so that the command can be interpreted as an action to launch the Netflix app. That is provided via the internet of things (IoT), which then provides the action request to the IottClient of the DeviceController of the soundbar. The soundbar then issues appropriate commands to a connected display device (such as the television shown), which can be done vie a connection to the display device or via an IR blaster to issue one or more IR command(s) and/or appropriate commands to other video content devices, such as a video streaming device (e.g., a Roku device, which may be, for example, a dongle, stick, or box). Note that the Frontdoor of the soundbar, which is the communication or messaging bus, may also be involved as shown, which could include the CAPS (content audio provider service, which is the source switching block) for the soundbar and/or other controllers, such as the ProductController shown. This method flow causes the television to be powered on, be on the right input source (HDMI1, in this example), and the Roku App to launch Netflix, which is a video streaming service.

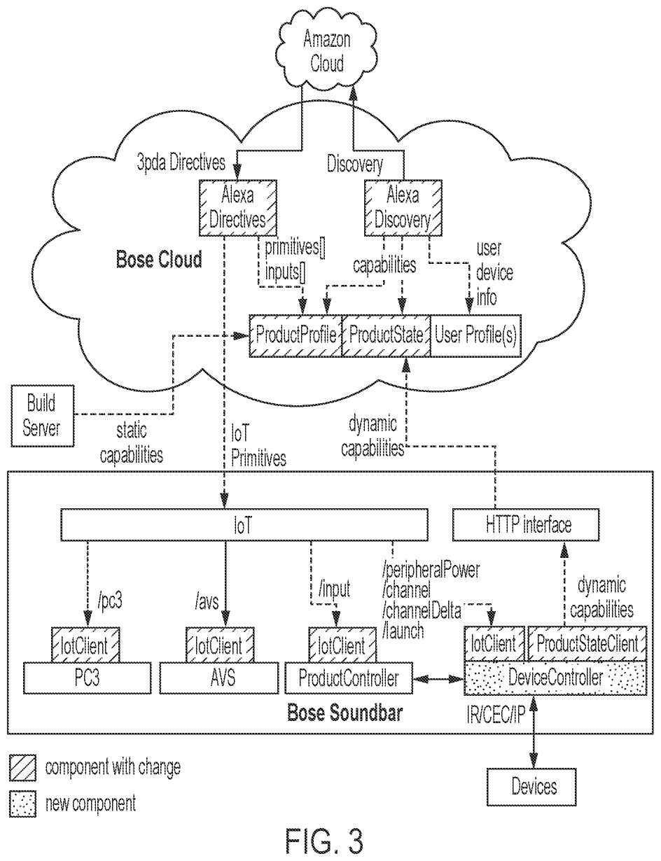

FIG. 3 illustrates an example system for providing voice control of a video playback system, in accordance with some implementations. The system shows how the soundbar can interact with the Amazon cloud and the Bose cloud (where the clouds provide internet-based services and storage) to provide the voice control capabilities described herein. Note that the IOT block of the soundbar provides inputs to the following blocks: PC3 (product cloud control client), AVS (Alexa voice service), and ProductController (controller for soundbar commands). Note that the various blocks shown in the soundbar may be included in one or more processors included in the soundbar. The DeviceController block provides commands to one or more external devices, such as to at least one of a display device (e.g., a TV), a set-top box, a cable box, a satellite box, a television tuner, a video streaming device, a gaming console, a mobile computing device, or a digital video disc (DVD) playback device.

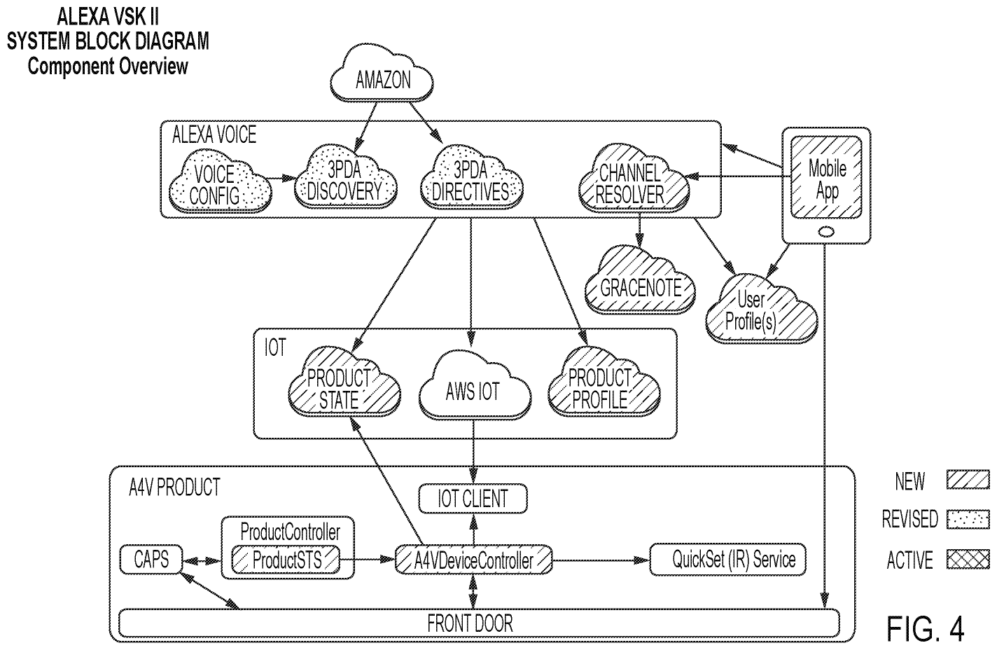

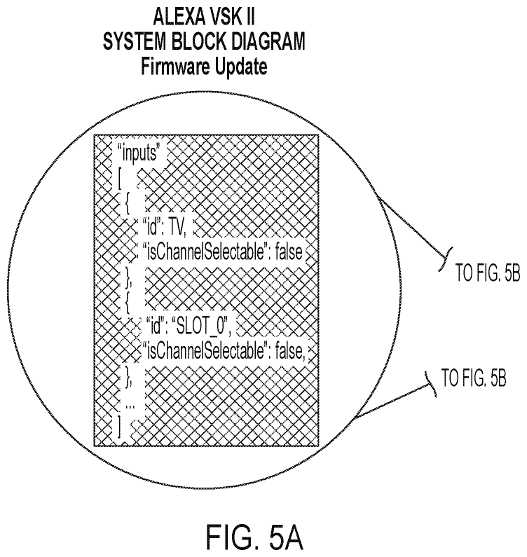

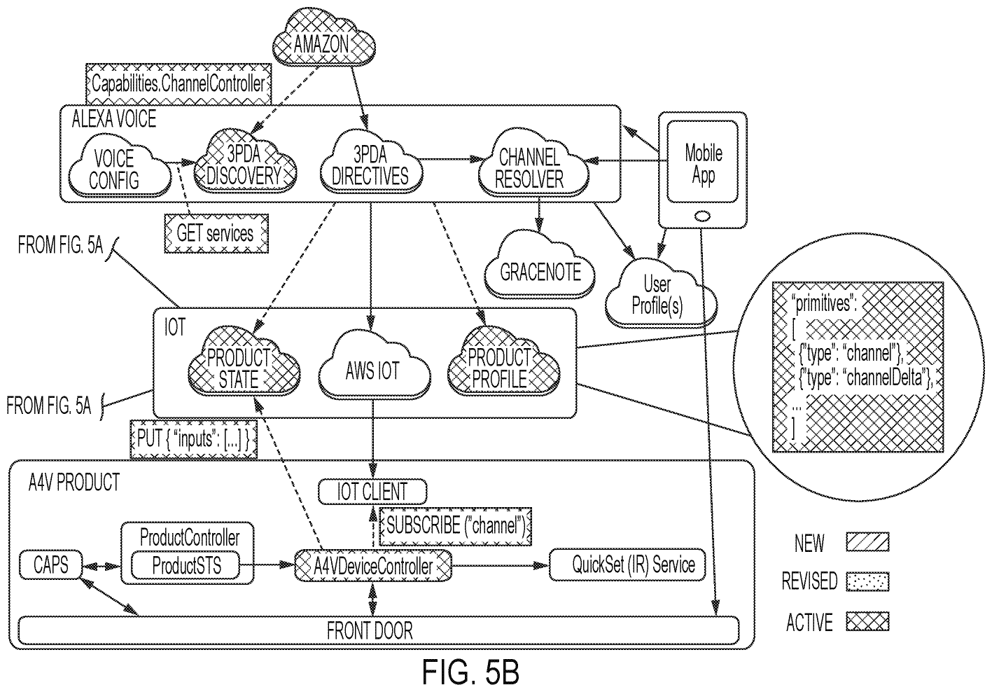

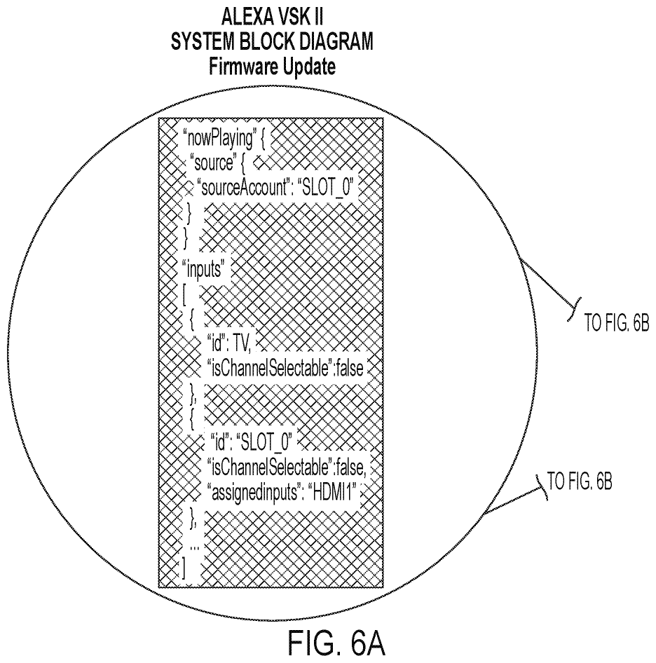

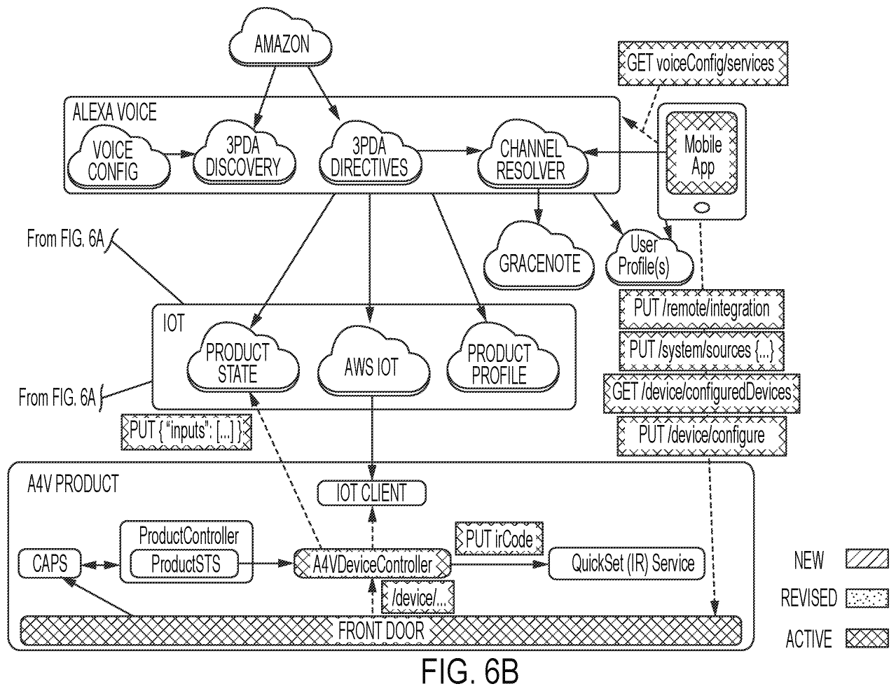

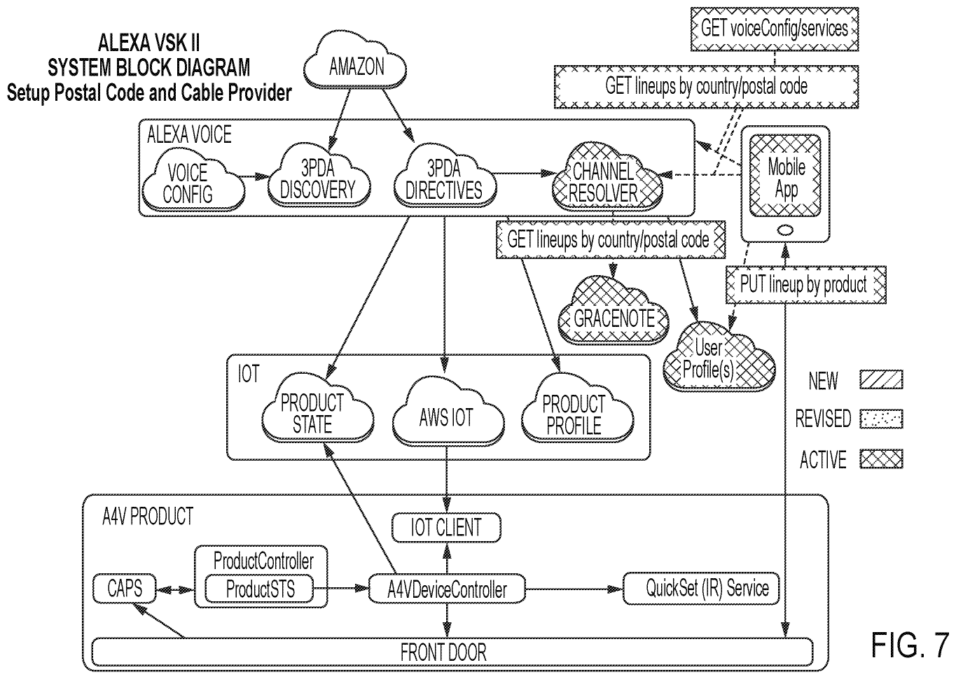

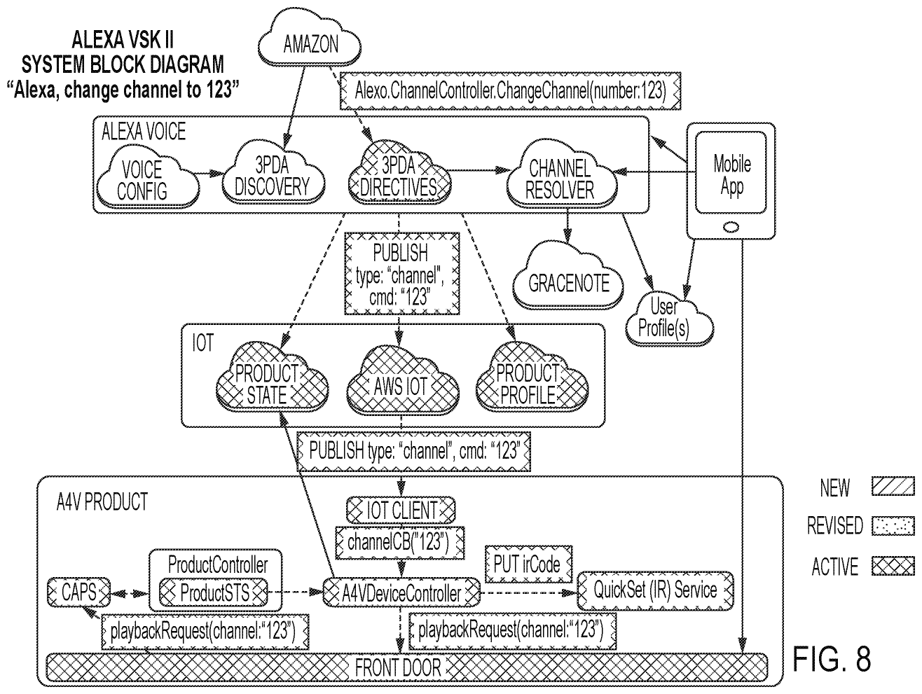

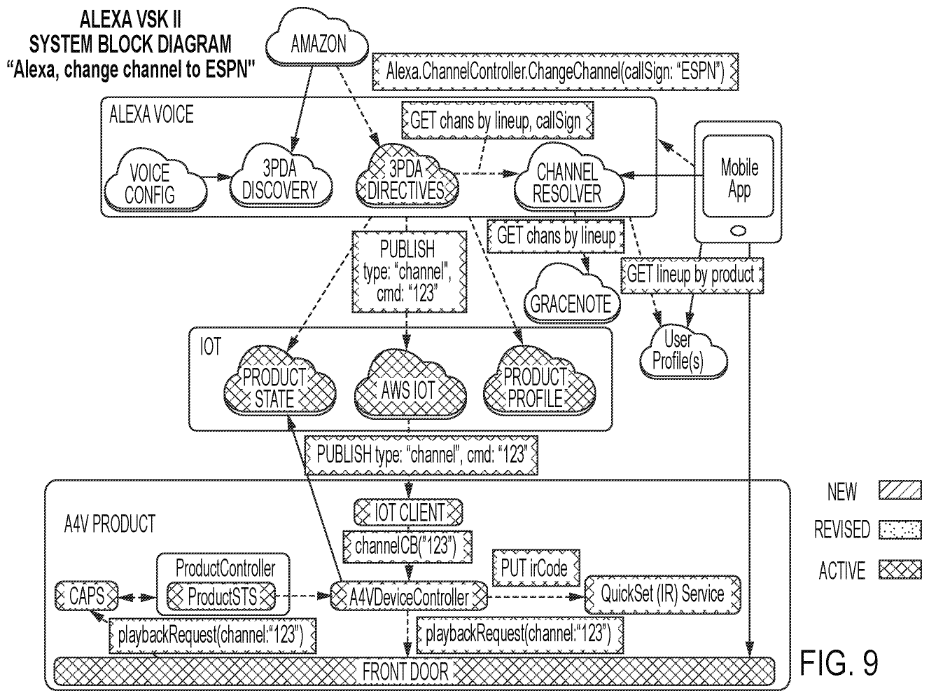

FIG. 4 illustrates an example system block diagram of a component overview for a system to provide voice control of a video playback system, in accordance with some implementations. This example system block shows how the soundbar (A4V product) interacts with the IOT (internet of things), the Alexa voice client, the Amazon cloud, Gracenote (which is a third-party service that helps convert television channel names into television channel number), a mobile application, and cloud data relating to one or more user profiles. Note that in some implementations, Gracenote (or another third-party service used to look up television channel names to find corresponding television channel numbers) may require setup that includes providing information related to the location (e.g., zip code), provider (e.g., cable or satellite content provider), and/or device (e.g., cable box or satellite box) that are a part of the video playback systems for which the voice control techniques described herein are used. FIGS. 5A-B illustrate a firmware update using the example system block diagram of FIG. 4, in accordance with some implementations. FIGS. 6A-B illustrate setting up a cable box source using the example system block diagram of FIG. 4, in accordance with some implementations. FIG. 7 illustrates setting the postal code and cable provider using the example system block diagram of FIG. 4, in accordance with some implementations. FIG. 8 illustrates providing an example voice command (“Alexa, change channel to 123”) using the example system block diagram of FIG. 4, in accordance with some implementations. FIG. 9 illustrates providing another example voice command (“Alexa, change channel to ESPN”) using the example system block diagram of FIG. 4, in accordance with some implementations.

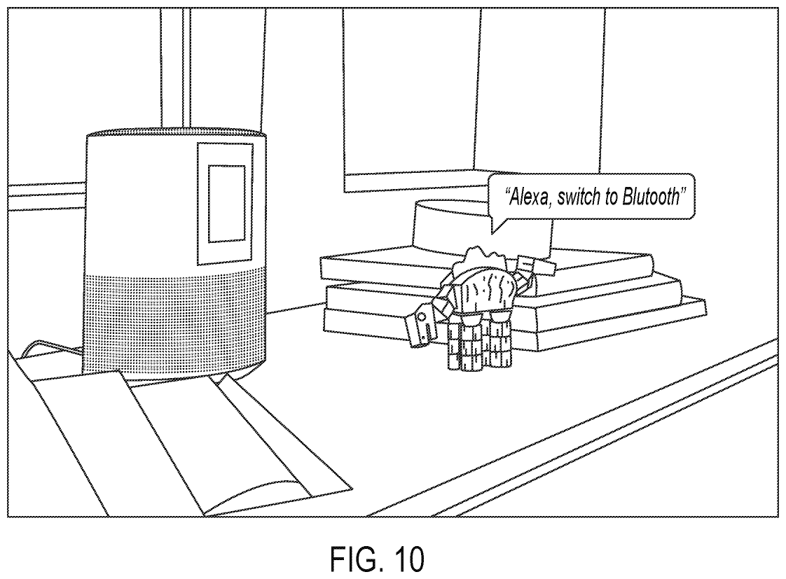

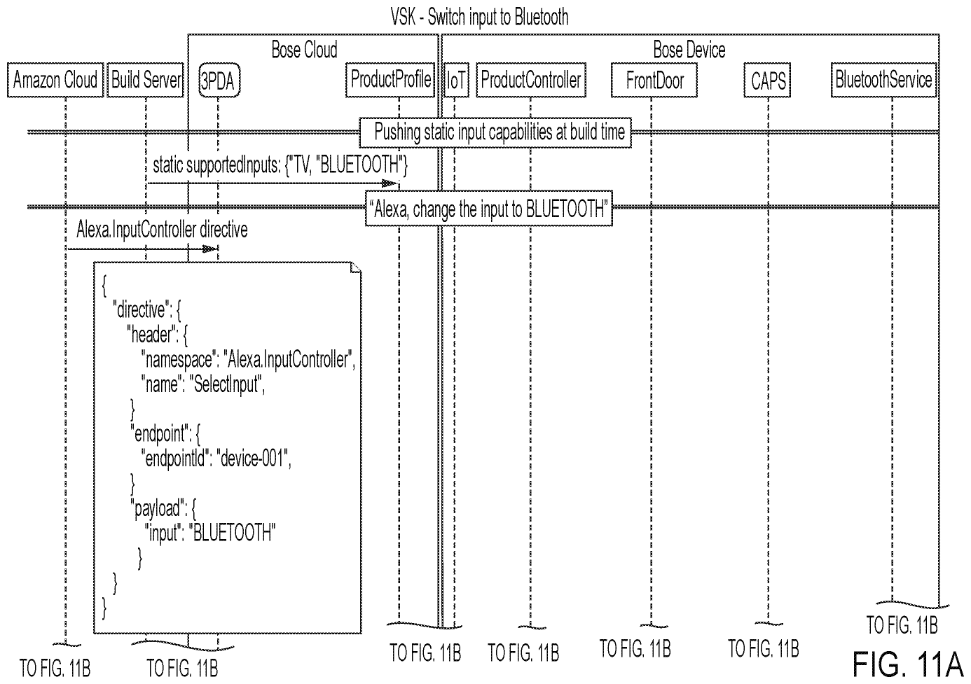

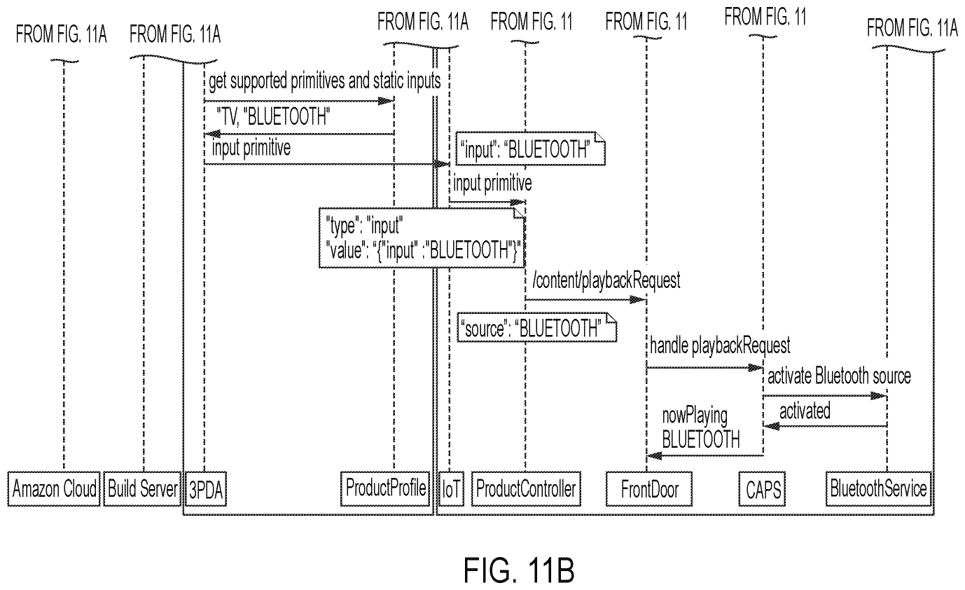

FIG. 10 illustrates another example voice command (“Alexa, switch to Bluetooth”) issued to a soundbar to provide voice control of a video playback system, in accordance with some implementations. FIGS. 11A-B illustrate a flow chart for switching the input to Bluetooth using the example system block diagram of FIG. 4, in accordance with some implementations. Thus, in addition to the video content changing actions that can be performed using the voice commands described herein, other commands, such as changing the audio source for the soundbar itself. Specifically in FIGS. 10 and 11A-B, the action is to change the audio input to Bluetooth, which could be a switch from an optical audio or HDMI input that was being used to receive audio for video content displayed on the connected display device, such as a TV. Note that FIGS. 11A-B include additional bloc component BluetoothService, which assists in switching the input to Bluetooth for the soundbar (or, more generally, for an audio device).

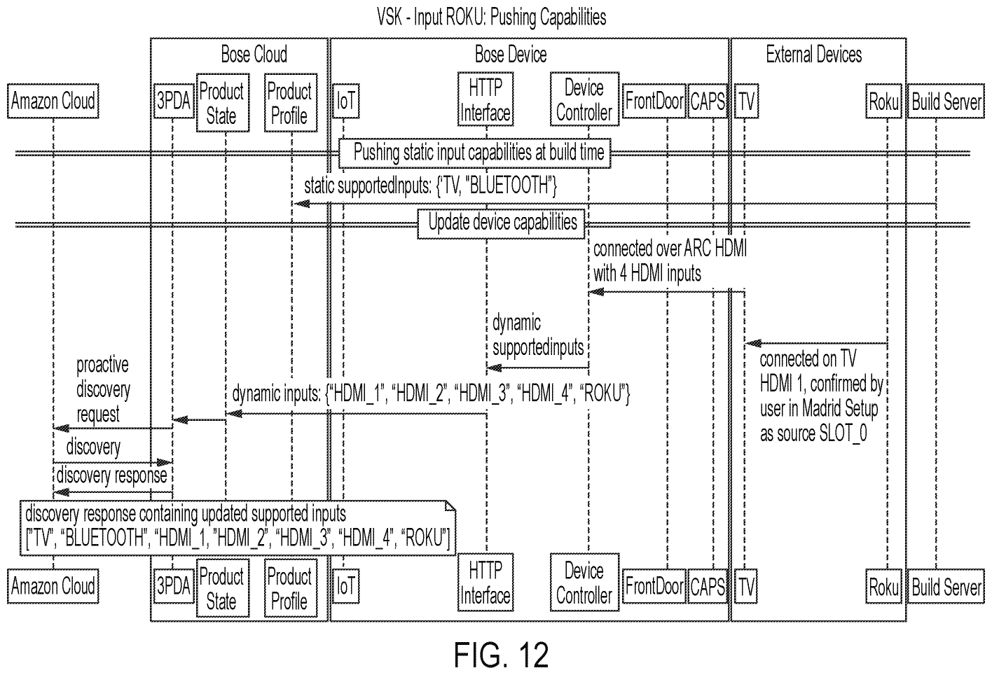

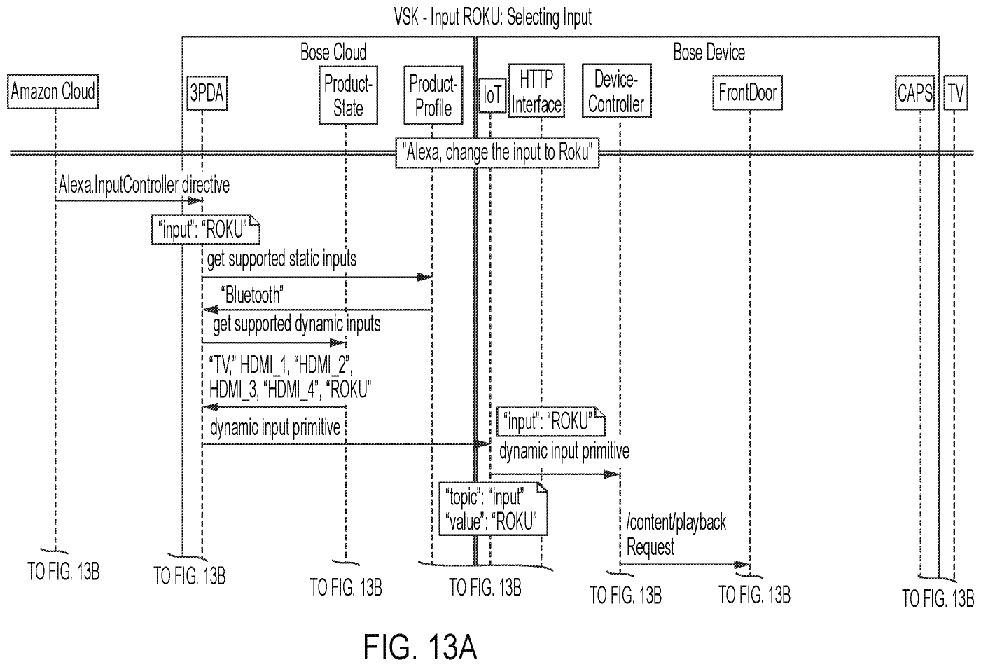

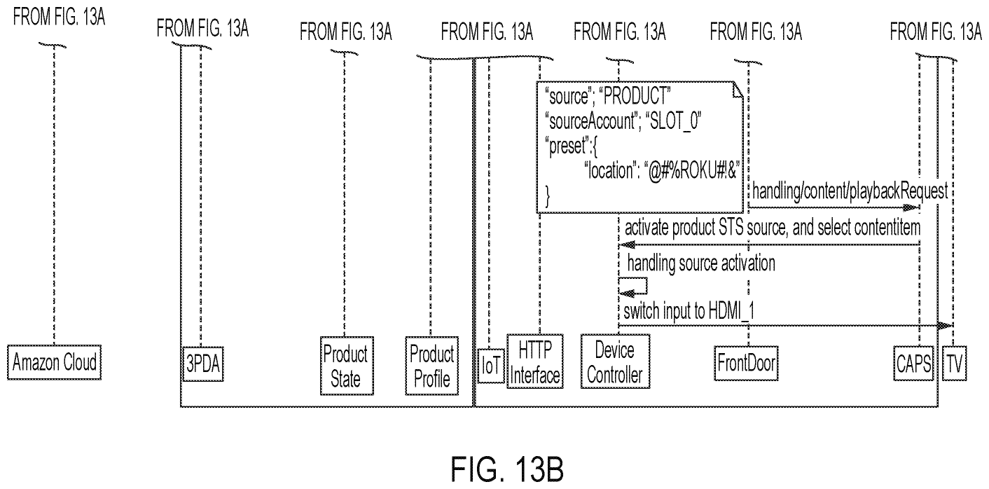

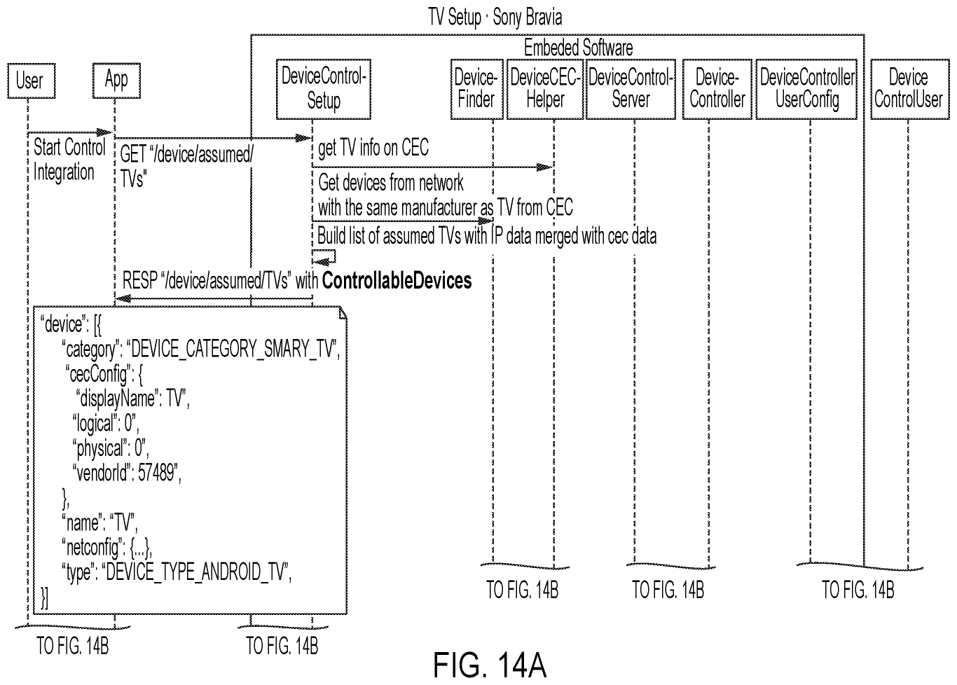

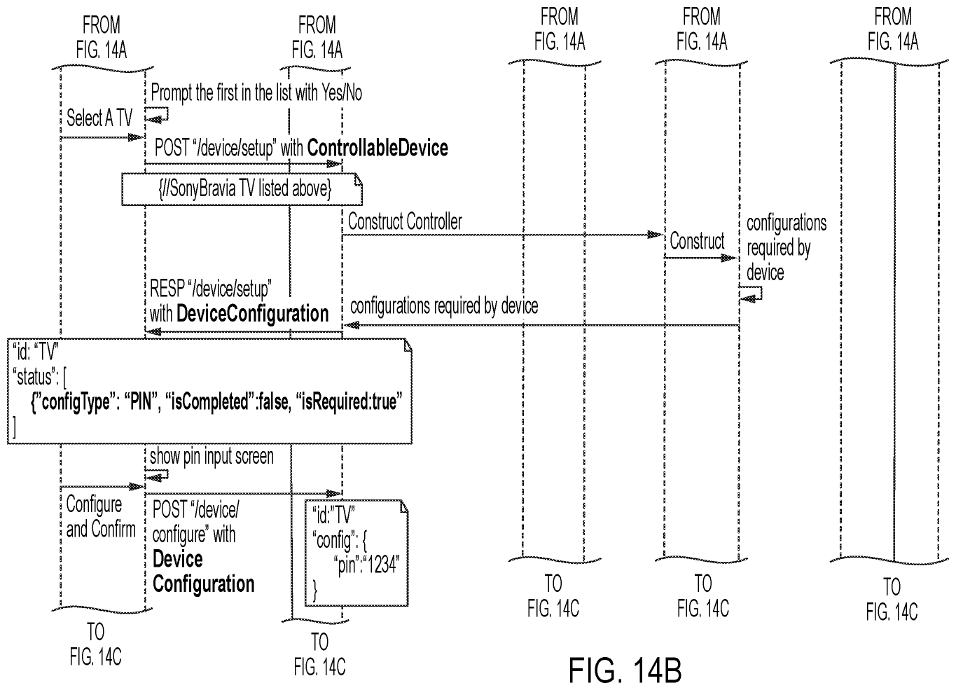

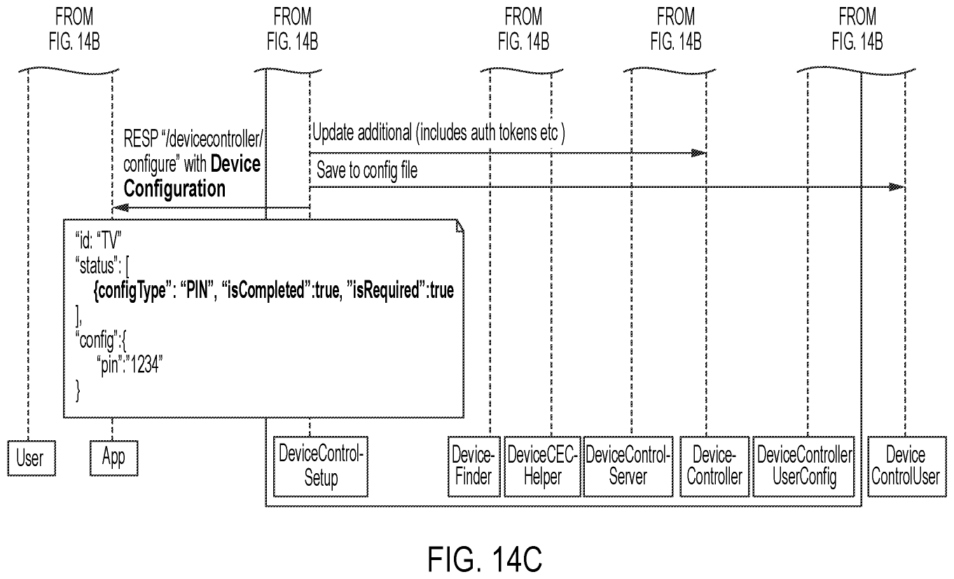

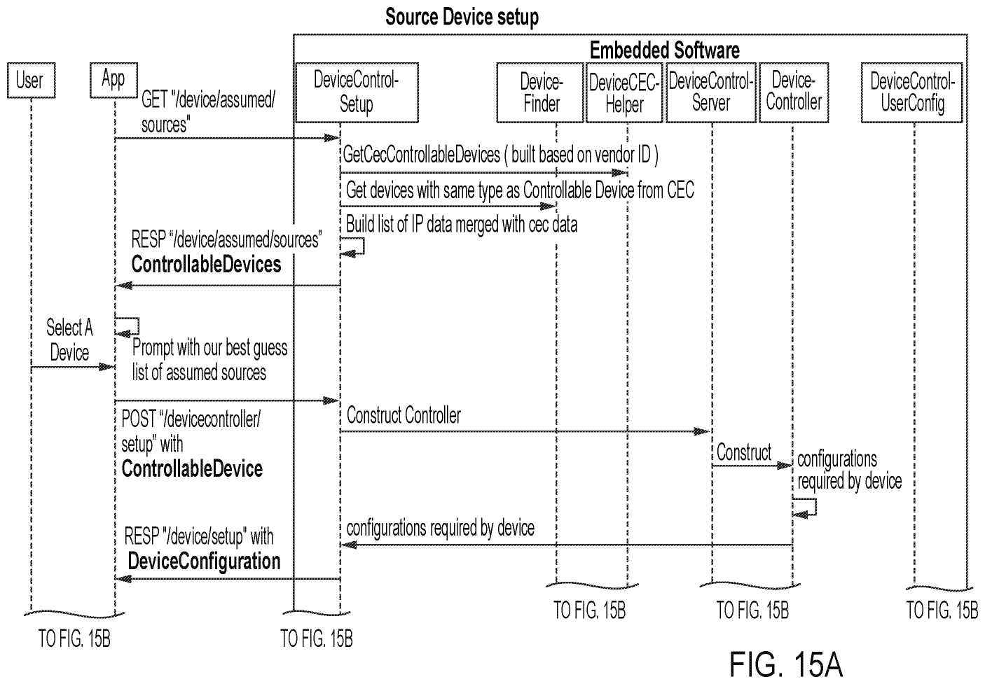

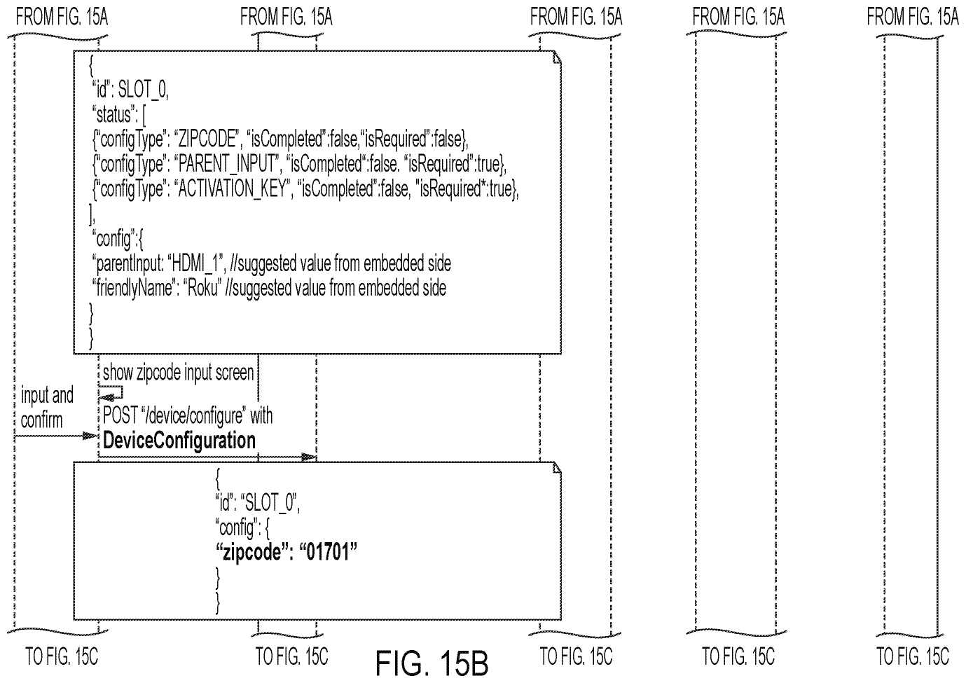

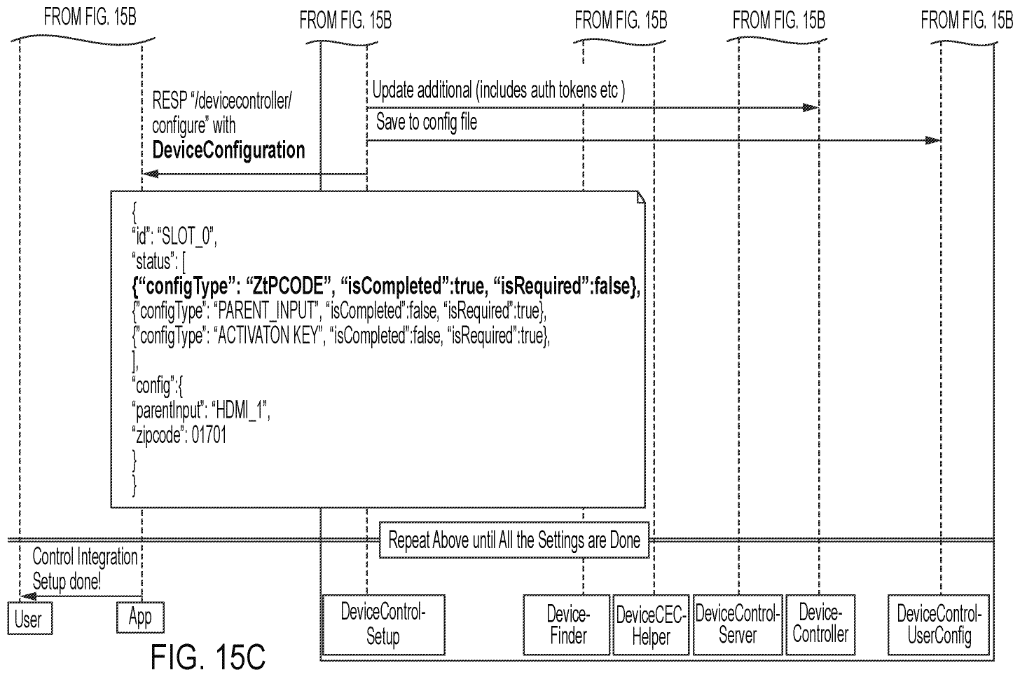

Additional flow charts are provided in the Figures to illustrate the processes involved with some of the techniques described herein. For example, using the example system block diagram of FIG. 4 (and possibly additional block components), FIG. 12 illustrates a flow chart for pushing commands to a streaming device (e.g., a ROKU box), FIGS. 13A-B illustrate a flow chart for selecting an input for a streaming device (e.g., a ROKU box), FIGS. 14A-C illustrate a flow chart for setting up a television (e.g., a Sony Bravia TV), and FIGS. 15A-C illustrate a flow chart for setting up a source device.

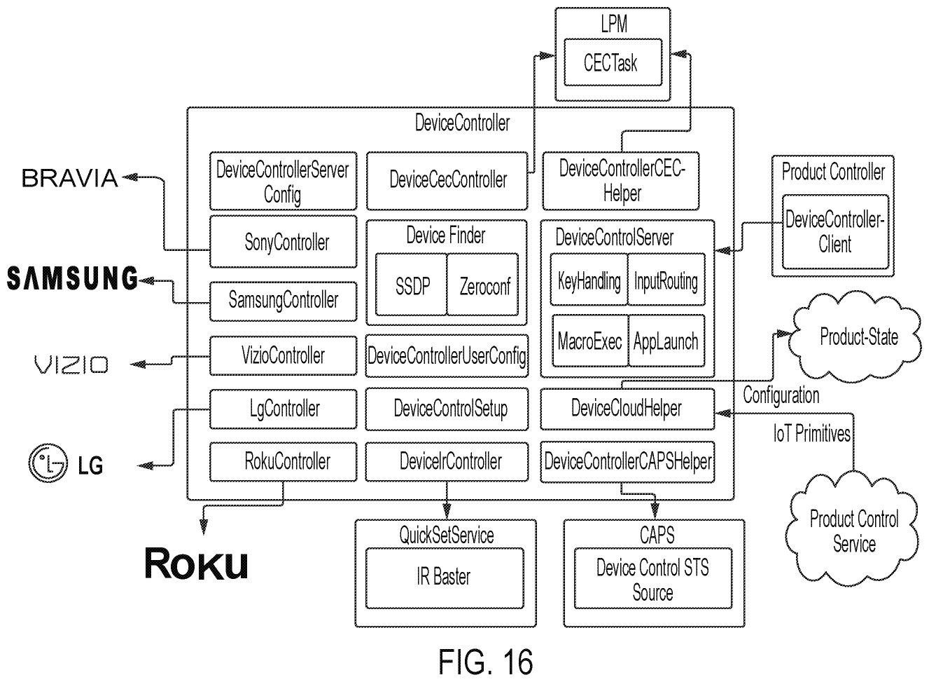

FIG. 16 illustrates a system block diagram of a device controller (DeviceController) for a system to provide voice control of a video playback system, in accordance with some implementations. As shown, the device controller includes numerous different blocks that perform functions to provide commands to different devices of a video playback system for which the voice control techniques described herein can be used. For instance, the device controller may come preconfigured to control various different display devices, such as multiple different TVs from different manufacturers, which is the case as shown with Controllers for TV companies Sony, Samsung, Vizio, and LG. The device controller also provides commands for the IR Blaster and the CAPS blocks of the soundbar.

The techniques variously described herein provide numerous benefits to a user, such as simplifying and expediting the control of video content on a TV (or other display device) that the user is consuming. In addition, voice controls do not require having possession of a working physical remote, which allows for a better and more convenient experience, and also easily allows a user to provide commands in the dark simply by using their voice. Further, multiple people could issue close-in-time voice commands to make changes to the video playback system without having to pass around a physical remote. For instance, one user could ask for the content (e.g., “Alexa, watch CNN”), and then another user could change the volume (e.g., “Alexa, volume up”). Numerous different variations and configurations can be understood based on this disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a device, a system, a method, and/or a computer program product at any possible technical detail level of integration. The computer program product may include a computer readable storage medium (or media) having computer readable program instructions thereon for causing a processor to carry out aspects of the present disclosure. The aforementioned computer program product, computer readable storage medium (or media) and/or computer readable program instructions may be non-transitory.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods that are not mutually inconsistent, is included within the scope of the present disclosure.

What is claimed is:

1. A device comprising:
at least one electro-acoustic transducer;
at least one microphone;
a connection to a display device, wherein the at least one electro-acoustic transducer is configured to output audio related to video content displayed by the display device; and
at least one processor configured to, in response to the microphone receiving a voice command, perform an action to cause a change in the video content displayed by the display device.

2. The device of claim 1, wherein the device is a soundbar.

3. The device of claim 1, wherein the at least one microphone includes multiple microphones arranged in an array for far-field voice pick up.

4. The device of claim 1, wherein the connection is a wired connection via one of an optical audio cable, a High-Definition Multimedia Interface (HDMI) cable, or a Universal Serial Bus (USB) cable.

5. The device of claim 1, wherein the connection is a wireless connection.

6. The device of claim 1, wherein the action causes a change to a channel providing the video content displayed by the display device.

7. The device of claim 1, wherein the voice command includes a video content service and the action causes the video content displayed by the display device to change to the video content service.

8. The device of claim 7, wherein the at least one processor is further configured to, in response to the voice command including the video content service, send an input change command to the display device to an input associated with the video content service.

9. The device of claim 8, wherein the at least one processor is further configured to provide a setup process that enables a user to associate the input with the video content service.

10. The device of claim 1, wherein the action to cause a change in the video content displayed by the display device includes changing an input or source of the video content.

11. The device of claim 10, wherein the at least one processor is further configured to allow a user to rename an input or source of video content, and wherein changing an input or source of the video content is performed in response to the voice command including a renamed input or source of video content.

12. The device of claim 1, wherein the at least one processor is further configured to,
in response to the microphone receiving the voice command, determine a power state of the display device, and,
in response to the display device power state being off, send a power command to the display device.

13. The device of claim 12, wherein determining the power state of the display device includes determining whether audio data is being received via the connection with the display device.

14. The device of claim 1, wherein the change in the video content displayed by the display device includes at least one of playing, pausing, stopping, rewinding, fast forwarding, skipping forward, skipping backward, or change episode.

15. The device of claim 1, further comprising at least one infrared (IR) blaster, wherein the action causes the IR blaster to transmit a command to a video content device connected to the display device to cause the change in the video content displayed by the display device.

16. The device of claim 15, further comprising a housing, wherein the at least one electro-acoustic transducer, the at least one microphone, the at least one processor, and the at least one IR blaster are all included in or on the housing.

17. The device of claim 1, wherein the at least one electro-acoustic transducer is configured to output the audio related to the video content displayed on the display device based on audio data received via the connection.

18. A method of voice controlling a video playback system using a device, the device including at least one electro-acoustic transducer, at least one microphone, a connection to a display device, and at least one processor, the method comprising:
outputting, via the at least one electro-acoustic transducer, audio related to video content displayed by the display device; and
in response to the microphone receiving a voice command, performing an action to cause a change in the video content displayed by the display device.

19. The method of claim 18, wherein the device further includes at least one infrared (IR) blaster, wherein the action causes the IR blaster to transmit a command to a video content device connected to the display device to cause the change in the video content displayed by the display device.

20. The method of claim 19, wherein the device further comprises a housing, wherein the at least one electro-acoustic transducer, the at least one microphone, the at least one processor, and the at least one IR blaster are all included in or on the housing.
